(19) United States
(12) Patent Application Publication
(10) Pub. No.: US 2025/0383428 A1
(43) Pub. Date: Dec. 18, 2025

(54) OPTICAL DEVICE, OPTICAL SYSTEM, MOVING BODY, AND DISTANCE MEASURING METHOD

(71) Applicant: CANON KABUSHIKI KAISHA, Tokyo (JP)

(72) Inventor: KAZUMA CHIDA, Kanagawa (JP)

(21) Appl. No.: 19/235,436

(22) Filed: Jun. 11, 2025

(30) Foreign Application Priority Data
Jun. 14, 2024 (JP) 2024-096895

(51) Int. Cl. G01S 7/484; G01S 7/481; G01S 7/4865; G01S 17/931

(52) U.S. Cl. CPC G01S 7/484; G01S 17/931; G01S 7/4816; G01S 7/4865

(57) ABSTRACT

An optical device includes a distance sensor and obtains distance information based on an output from the distance sensor, the device also includes a processor configured to perform reduction processing of reducing, based on movement of the distance sensor in an optical axis direction of the distance sensor, an influence of the movement on the distance information.

### BACKGROUND

### Field of the Technology

The present disclosure relates to an optical device, an optical system, a moving body, and a distance measuring method.

### Description of the Related Art

A Time of Flight (ToF) distance measuring device is known, which performs distance measurement by irradiating an object with light from a light source and detecting the light reflected by the object. Japanese Patent Laid-Open No. 2023-174180 discloses that a distance measurement frame for obtaining one distance image is constituted by a plurality of subframes, and each subframe is constituted by a plurality of microframes. The pixels constituting the distance measurement frame each have the information of the distance from the distance measuring device to an object as a pixel value. This distance is calculated from the time between the emission of light from the distance measuring device and the reception of reflected light. The plurality of subframes differ in measurement period for measuring reflected light. A pixel of each subframe has a pixel value corresponding to the number of photons received in the measurement period (subframe period) of the subframe. The pixel value is expressed by a plurality of bits. Each of the pixels of the plurality of microframes constituting each subframe has a pixel value indicating whether a photon is received in the measurement period (microframe period) assigned to the microframe. The pixel value is expressed by one bit.

In an optical device that obtains distance information by using a distance sensor, if the distance sensor is vibrating or moving in the optical axis direction (distance measuring direction) of the distance sensor, the measurement accuracy can deteriorate.

### SUMMARY

The present disclosure provides a technique advantageous in improving the measurement accuracy.

The present disclosure provides an optical device that includes a distance sensor and obtains distance information based on an output from the distance sensor, the device further includes a processor configured to perform reduction processing of reducing, based on movement of the distance sensor in an optical axis direction of the distance sensor, an influence of the movement on the distance information.

Further features of the present disclosure will become apparent from the following description of exemplary embodiments with reference to the attached drawings.

### BRIEF DESCRIPTION OF THE DRAWINGS

FIG. 1 is a block diagram exemplarily showing the arrangement of an optical device according to one or more aspects of the present disclosure;

FIG. 2 is a view exemplarily showing an operation timing in a ToF method in the optical device according to one or more aspects of the present disclosure;

FIGS. 3A and 3B are graphs exemplarily showing the operation of the optical device according to one or more aspects of the present disclosure;

FIGS. 4A and 4B are graphs showing a comparative example for explaining the operation of the optical device according to one or more aspects of the present disclosure;

FIG. 5 is a graph exemplarily showing the operation of the optical device according to one or more aspects of the present disclosure;

FIG. 6 is a block diagram exemplarily showing the arrangement of an optical device according to one or more aspects of the present disclosure;

FIG. 7 is a block diagram exemplarily showing the arrangement of an optical device according to one or more aspects of the present disclosure;

FIGS. 8A and 8B are graphs exemplarily showing the operation of the optical device according to one or more aspects of the present disclosure;

FIG. 9 is a block diagram exemplarily showing the arrangement of an optical device according to one or more aspects of the present disclosure;

FIG. 10A is a view exemplarily showing the operation of the optical device according to the fourth embodiment;

FIG. 10B is a view exemplarily showing the operation of the optical device according to one or more aspects of the present disclosure;

FIG. 11A is a view showing a comparative example for explaining the operation of the optical device according to one or more aspects of the present disclosure;

FIG. 11B is a view showing a comparative example for explaining the operation of the optical device according to one or more aspects of the present disclosure;

FIG. 12 is a graph exemplarily showing the operation of the optical device according to one or more aspects of the present disclosure;

FIG. 13 is a block diagram exemplarily showing the arrangement of an optical device according to one or more aspects of the present disclosure;

FIGS. 14A and 14B are views exemplarily showing the operation of the fifth embodiment;

FIG. 15 is a flowchart showing the operation of the optical device according to one or more aspects of the present disclosure;

FIG. 16 is a block diagram showing an example of the arrangement of an image sensor that can be incorporated in the distance sensor;

FIG. 17 is a circuit diagram showing an example of the arrangement of a pixel of the image sensor; and

FIGS. 18A and 18B are views showing examples of an optical system and a moving body according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

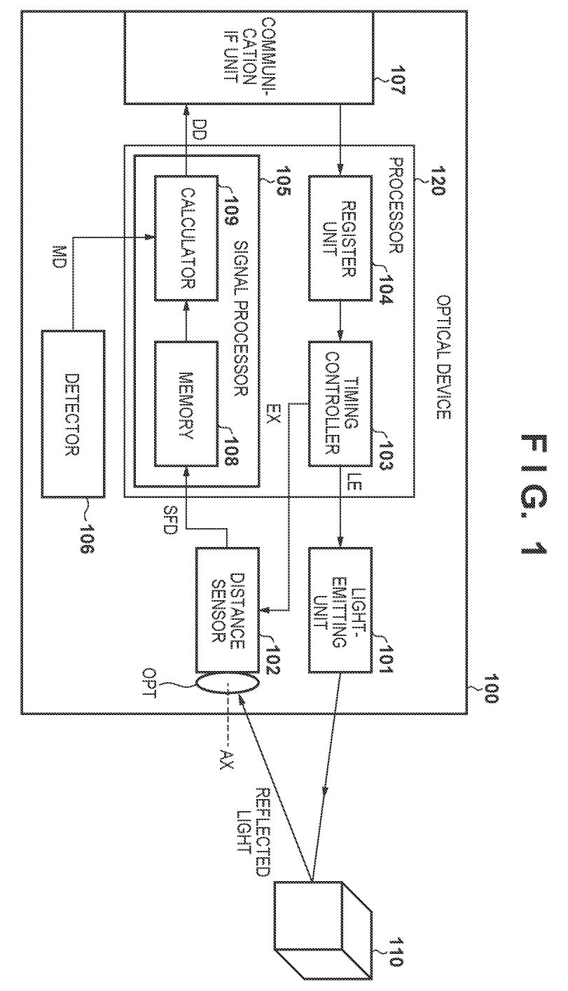

The arrangement and operation of an optical device 100 according to the first embodiment will be described with reference to FIGS. 1, 2, 3A, 3B, 4A, 4B, 5, and 15. The optical device 100 is configured to obtain distance information indicating the distance between the optical device 100 and an object 110. The optical device 100 may be understood as a distance measuring device. The object 110 can be any object that reflects light. Although FIG. 1 shows one object 110, the optical device 100 can be configured to obtain distance information of a plurality of objects in the visual field (the region where measurement is performed). The optical device 100 can be configured to include a distance sensor 102 and obtain distance information based on an output from the distance sensor 102. The optical device 100 can include a processor 120 that performs the reduction processing of reducing the influence of the movement of the distance sensor 102 on distance information based on the movement (for example, the movement amount) of the distance sensor 102 in an optical axis direction AX of the distance sensor 102.

The optical device 100 can include a light-emitting unit 101 that emits light in the optical axis direction of the distance sensor 102. If the object 110 is present in the visual field of the optical device 100, the light emitted from the light-emitting unit 101 can be reflected by the object 110 and enter, as the reflected light, the distance sensor 102. The optical axis direction of the distance sensor 102 is a direction in which the distance between the optical device 100 and the object 110 is measured. The distance sensor 102 can include a photoelectric converter such as an image sensor and an optical system OPT that focuses the reflected light on the light-receiving surface of the photoelectric converter. The optical axis direction AX can be understood as the optical axis direction of the optical system OPT. The optical system OPT can be replaceable. All or part of the optical system OPT may be shared by an optical system that allows the light-emitting unit 101 to emit light within the visual field of the optical device 100.

The optical device 100 can include a detector 106 that detects the movement (for example, the movement amount) of the optical device 100 or the distance sensor 102 in the optical axis direction AX and outputs movement data MD indicating the detected movement. The detector 106 can include at least one of an acceleration sensor and a displacement sensor. If the distance sensor 102 is vibrating in the optical axis direction AX, the movement of the distance sensor 102 in the optical axis direction AX can include the vibration. If the distance sensor 102 is moving in a direction intersecting the optical axis direction AX, the movement of the distance sensor 102 in the optical axis direction AX means a component parallel to the optical axis direction AX. The processor 120 can perform the reduction processing of reducing the influence of the movement of the distance sensor 102 in the optical axis direction AX on distance information DD based on an output (the movement data MD) from the detector 106. The processor 120 can generate the distance information DD by correcting the information obtained by an output from the distance sensor 102 based on an output indicating the detection result obtained by the detector 106 in a measurement period in which the distance sensor 102 performs measurement.

A more specific arrangement example will be described below. The optical device 100 can include a communication IF (interface) unit 107 for communicating with other devices. The optical device 100 can receive control information or transmit the distance information DD via the communication IF unit 107. The processor 120 can include, for example, a register unit 104, a timing controller 103, and a signal processor 105. The signal processor 105 can include a memory 108 that stores a plurality of subframes SFD output from the distance sensor 102. The signal processor 105 can also include a calculator 109 that generates the distance information DD based on outputs (the movement data MD) from the plurality of subframes SFD and the detector 106, which are stored in the memory 108. The calculator 109 can perform the reduction processing of reducing the influence of the movement of the distance sensor 102 in the optical axis direction AX on distance information based on an output (the movement data MD) from the detector 106. In other words, the calculator 109 corrects the information obtained from the plurality of subframes SFD, which is held in the memory 108, based on an output (the movement data MD) from the detector 106 and generates the distance information DD based on the corrected information.

The light-emitting unit 101 can include a light source that emits light in response to a light emission control signal LE as the first timing control signal generated by the timing controller 103. That the timing controller 103 generates the light emission control signal LE is equivalent to that the timing controller 103 activates the light emission control signal LE. The light source can be, for example, a semiconductor laser diode. The light source can emit light having a predetermined pulse width in accordance with the light emission control signal LE supplied from the timing controller 103. The light-emitting unit 101 may have an optical member (not shown) such as a diffusion plate. The light emitted from the light source can be diffused and applied in a predetermined two-dimensional range.

The distance sensor 102 has one or a plurality of photoelectric conversion elements and can output a plurality of subframes (subframe data) SFD differing in measurement period. A distance measurement frame (distance measurement frame data) is generated based on a plurality of subframes. In this case, a measurement period is an exposure period of a photoelectric conversion element, that is, a period in which a signal is generated by photoelectric conversion. A pixel of each subframe has a pixel value corresponding to the amount of light (for example, the number of photons) received in a measurement period of the subframe. The pixel value can be expressed by a plurality of bits. An exposure period of a photoelectric conversion element in a subframe period for the acquisition of each subframe can be controlled by an exposure control signal EX as the second timing control signal generated by the timing controller 103. That the timing controller 103 generates the exposure control signal EX is equivalent to that the timing controller 103 activates the exposure control signal EX. The distance sensor 102 can include, for example, a CMOS sensor or SPAD sensor. For example, two-dimensionally arranging a plurality of photoelectric conversion elements like a CMOS image sensor or SPAD image sensor can obtain two-dimensional distance information, that is, a distance image.

The timing controller 103 activates the exposure control signal EX over a plurality of times with reference to the activation timing of the light emission control signal LE in a distance measurement frame period for the generation of a distance measurement frame. The register unit 104 can hold control information for controlling the operation of the optical device 100.

The memory 108 stores or holds the plurality of subframes SFD output from the distance sensor 102. The calculator 109 corrects the information obtained from the plurality of subframes SFD stored in the memory 108 based on the output (the movement data MD) from the detector 106 and generates the distance information DD based on the corrected information. The following will be explained as an example in which the distance sensor 102 includes a plurality of photoelectric conversion elements and outputs an image having a pixel value corresponding to the amount of light (for example, the number of photons) received by each pixel in each subframe period. In each subframe, a pixel having a pixel value equal to or more than a predetermined value indicates the reception of light emitted from the light-emitting unit 101 and reflected by the object 110 in an exposure period for the subframe. The calculator 109 can generate the distance information DD indicating the distance between the optical device 100 and the object 110 from the time difference between the light emission period and the exposure period in each subframe. Such a method is called a ToF (Time of Flight) method.

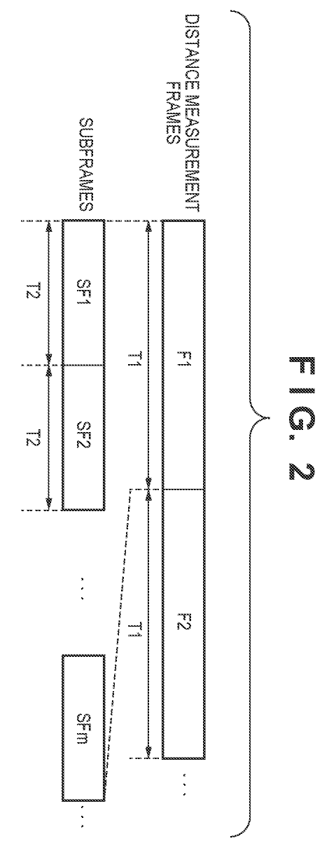

FIG. 2 is a view exemplarily showing the operation timing in the ToF method in the optical device 100 according to the first embodiment. Referring to FIG. 2, a period T1 for obtaining each of distance measurement frames F1, F2,..., is a distance measurement frame period. Each distance measurement frame period is constituted by a plurality (m in this case) of subframe periods T2. The subframes SF1, SF2,... SFm are respectively acquired in the plurality of subframe periods T2. The distance measurement frames F1, F2,... are also comprehensively written as distance measurement frames F, and the subframes SF1, SF2,..., SFm are also comprehensively written as subframes SF. The distance measurement frame F that generates one piece of distance information is generated based on the plurality of subframes SF.

Each subframe period T2 defines the temporal relationship between the light emission timing at which the light-emitting unit 101 emits light and the exposure period (measurement period) in which the distance sensor 102 performs an exposure operation. The distance sensor 102 operates at a timing corresponding to the light emission timing of the light-emitting unit 101. A pixel (pixel signal) in each subframe SF has a pixel value corresponding to the amount of light (for example, the number of photons) received in the exposure period (measurement period) of the subframe SF. The pixel value can be expressed by a plurality of bits. Each subframe SF can be generated based on a plurality of microframes. More specifically, the pixel value of each pixel of each subframe SF can be generated by calculating the sum of pixel values of a plurality of microframes for each pixel. A pixel in each microframe has a pixel value indicating whether a unit amount of light (for example, photons) is received in a measurement period (microframe period) assigned to the microframe. The pixel value can be expressed by one bit.

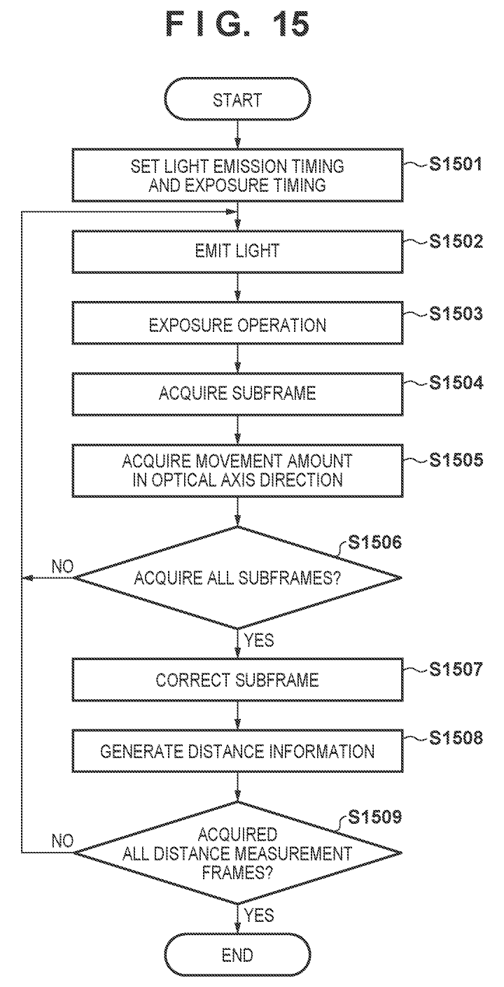

FIG. 15 is a flowchart showing the operation of the optical device 100 according to the first embodiment. This operation can be understood as a distance measuring method of measuring a distance by using the distance sensor 102. In step S1501, control information for setting the light emission timing (that is, the timing of activating the light emission control signal LE) of the light-emitting unit 101 and the exposure timing (that is, the timing of activating the exposure control signal EX) can be stored in the register unit 104.

Steps S1502 to S1509 are steps for acquiring one or the plurality of distance measurement frames F. Steps S1502 to S1505 are steps for acquiring one subframe SF. In step S1502, the timing controller 103 activates the light emission control signal LE to cause the light-emitting unit 101 to emit light. In step S1503, the timing controller 103 activates the exposure control signal EX over the set exposure period (measurement period) and causes the distance sensor 102 to perform an exposure operation. In step S1504, the signal processor 105 acquires the subframe SFD as the data of one subframe SF from the distance sensor 102 and stores the subframe SFD in the memory 108. In step S1505, the signal processor 105 acquires the detection result (the movement data MD) acquired by the detector 106 in an exposure period (measurement period) and stores the result in the calculator 109. Note that steps S1504 and S1505 can be executed concurrently. In step S1506, the signal processor 105 determines whether all the subframes SF for generating one distance measurement frame are obtained. If not all the subframes SF are acquired yet, the signal processor 105 further executes steps S1502 to S1505. In contrast, if all the subframes SF are acquired, the signal processor 105 executes step S1507. In step S1507, the signal processor 105 (the calculator 109) generates distance information (second distance information) based on the plurality of subframe data SFD (first distance information) stored in the memory 108 and the detection result acquired by the detector 106 in accordance with each of the plurality of subframes SF. In step S1507, the signal processor 105 may execute step S1507 after steps S1504 and S1505 and before step S1506.

In step S1509, the signal processor 105 determines whether all distance measurement frames F are acquired. If not all the distance measurement frames F are acquired yet, the signal processor 105 executes steps S1502 to S1508. If all the distance measurement frames F are acquired, the signal processor 105 terminates the operation shown in FIG. 15.

Step S1504 can be understood as an example of the acquisition step of acquiring the first distance information by using a distance sensor in a given period. Step S1505 can be understood as an example of the detection step of detecting the movement of a distance sensor AX in the optical axis direction AX of the distance sensor 102 in the period. Steps S1507 and S1508 can be understood as the generation step of generating second distance information based on the first distance information acquired in the acquisition step and the detection result obtained in the detection step.

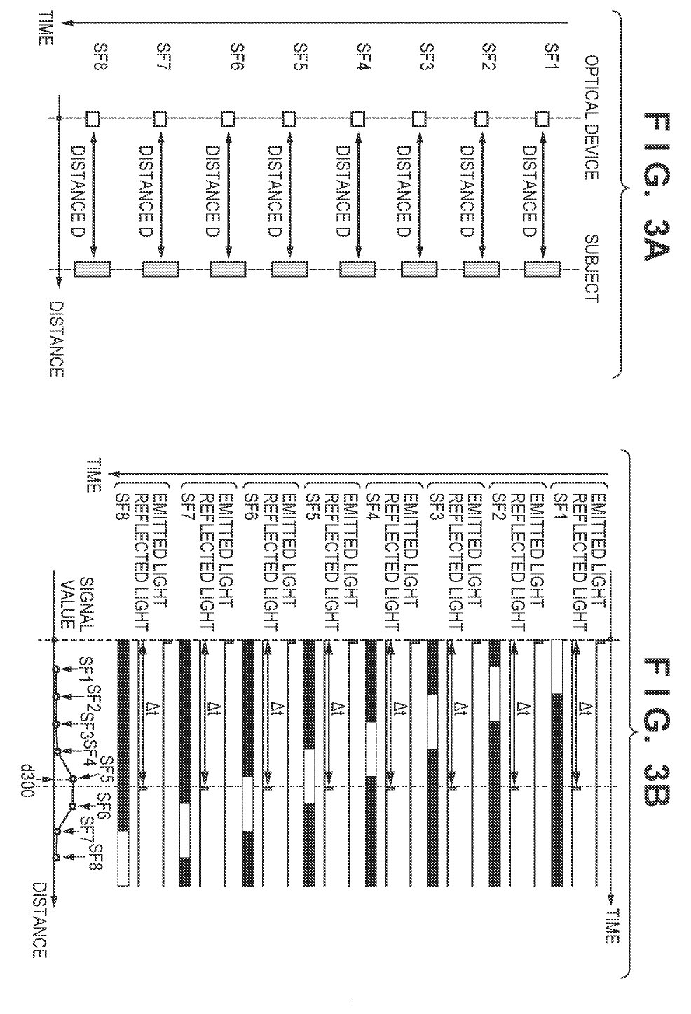

FIGS. 3A and 3B schematically show the operation of the optical device 100 in a case where the optical device 100 does not move in the optical axis direction AX in a period in which a distance measurement frame is acquired. FIG. 3A shows the positional relationship between the optical device 100 and the object 110 in the subframes SF1 to SF8. In this case, in the subframes SF1 to SF8, the optical device 100 does not move in the optical axis direction AX. A distance D is the distance between the optical device 100 and the object 110. FIG. 3B exemplarily shows the light emission timing of the light-emitting unit 101 in each of the subframes SF1 to SF8, the incident timing at which reflected light enters the distance sensor 102, and the exposure timing of the distance sensor 102. Referring to FIG. 3B, "EMITTED LIGHT" indicates the light emission timing at which the light-emitting unit 101 emits light, and "REFLECTED LIGHT" indicates the incident timing at which reflected light from the object 110 enters the distance sensor 102. Referring to FIG. 3B, of the bar shown on the right side of each of "SF1" to "SF8" indicating subframe periods for acquiring the subframes SF1 to SF8, the white bar indicates an exposure period, and the black bar indicates a non-exposure period. In addition, "Δt" indicates the time difference between the light emission timing at which the light-emitting unit 101 emits light and the timing at which reflected light enters the distance sensor 102. Furthermore, "SIGNAL VALUE" indicates the pixel value of a given pixel in each of the subframes SF1 to SF8, and "DISTANCE" indicates the value obtained by converting the exposure period of each of the subframes SF1 to SF8 into a distance.

In the case shown in FIGS. 3A and 3B, in each of the periods for acquiring the subframes SF5 and SF6, the distance sensor 102 detects reflected light from the object 110. The signal values in the subframes SF5 and SF6 are larger than the signal values in other subframes. The calculator 109 can determine a distance d300 between the optical device 100 and the object 110 based on each of the signal values of the subframes SF1 to SF8. The calculator 109 can determine the leading edge position of each signal value in the subframes SF1 to SF8 and specify the subframe (in this case, the subframe SF5) in which the object 110 is detected from the leading edge position. The calculator 109 can determine the distance (distance information) from a middle position in the exposure period of the subframe.

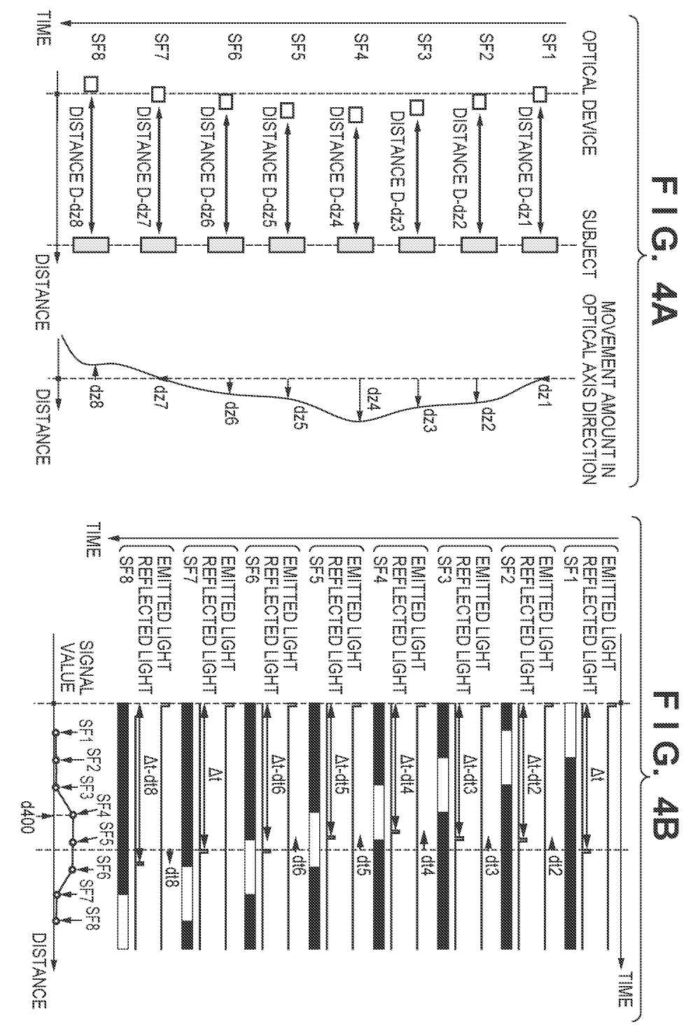

FIGS. 4A and 4B schematically show the operation (a comparative example) of the optical device 100 in a case where reduction processing (correction processing) is not executed even though the optical device 100 moves in the optical axis direction AX in a period in which a distance measurement frame is acquired. FIG. 4A shows the positional relationship between the optical device 100 and the object 110 in each of the subframes SF1 to SF8. In this case, as indicated by movement amounts dz1 to dz8, the optical device 100 moves in the optical axis direction AX in the subframes SF1 to SF8. In this case, dz1 and dz7 are 0. The movement of the optical device 100 can be caused by, for example, device shake, the shake of the base on which the optical device 100 is mounted, and the movement of a moving body such as a vehicle on which the optical device 100 is mounted. In this case, the distance between the optical device 100 and the object 110 becomes the shortest in the subframe SF4. The notation in FIG. 4B is the same as that in FIG. 3B. As shown in FIG. 4B, as the optical device 100 moves in the optical axis direction AX, the time difference between the timing at which the light-emitting unit 101 emits light and the timing at which reflected light enters the distance sensor 102 shifts from Δt. Note that dt2 to dt6 and dt8 are the values obtained by converting movement amounts dz2 to dz6 and dz8 into times (the values obtained by dividing the movement amounts by the luminous fluxes).

Unlike in the case shown in FIGS. 3A and 3B, in the case shown in FIGS. 4A and 4B, in the subframe SF4 as well, reflected light is detected by the distance sensor 102, and a significant signal value is obtained. If a distance (distance information) is determined based on the subframe SF in which the signal value rises, the result is a distance d400. As compared with a distance d300, an error occurs in the distance measurement result by an amount corresponding to a distance corresponding to one subframe.

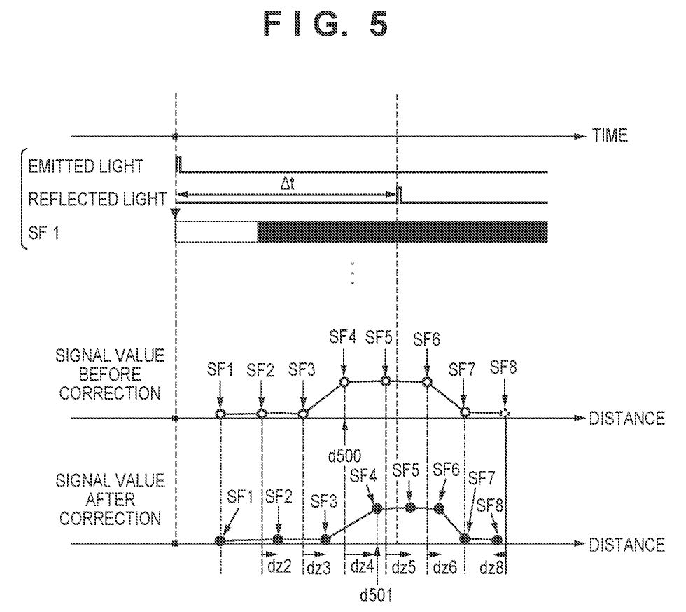

FIG. 5 schematically shows reduction processing (correction processing) in the optical device 100 according to the first embodiment. The positional relationship between the optical device 100 and the object 110 in the subframes SF1 to SF8 is the same as that in the case shown in FIG. 4A. The light emission timing of the light-emitting unit 101 in each of the subframes SF1 to SF8, the exposure timing of the distance sensor 102, and the incident timing at which reflected light enters the distance sensor are the same as those in the case shown in FIG. 4A.

The detector 106 can detect the movement (for example, the movement amount) of the distance sensor 102 in the optical axis direction AX in an exposure period (measurement period) of the distance sensor 102 and provide the movement data MD (dz1 to dz8) indicating the detection result to the calculator 109. The calculator 109 generates distance information (second distance information) based on the data (first distance information) of the plurality of subframes SF1 to SF8 stored in the memory 108 and the detection results (dz1 to dz8) obtained by the detector 106 in accordance with each of the plurality of subframes SF1 to SF8. The calculator 109 obtains, for example, distance values after correction by adding movement amounts dz2 to dz8 based on the movement amount dz1 in the period for acquiring the subframe SF1 to the distances obtained from the respective subframes SF. For example, since the signal value rises in the subframe SF4, if the object 110 is estimated to be detected in the subframe SF4, the movement amount dz4 detected at the time when the subframe SF4 is acquired to a distance d500 corresponding to the subframe SF4. At this time, the finally obtained distance (corrected distance) becomes d501. This makes it possible to cancel out or reduce the influence (error factor) of the movement of the optical device 100 in the optical axis direction AX, thereby reducing the distance measurement error. Assuming that the exposure period of each subframe SF is 600 ps (corresponding to 9 cm) and the shift amount of the exposure time for each subframe SF is 300 ps (corresponding to 4.5 cm), it is possible to correct the movement amount with an amplitude movement amount of about several cm corresponding to device shake, body shake, or the like in SF4.

In the above case, it is assumed that the optical device continuously moves in the optical axis direction over a plurality of subframe periods. However, reduction processing is also effective in a case where the optical device intermittently moves in the optical axis direction in, for example, only one subframe period. In the above case, the movement amount of the optical device in the optical axis direction is calculated with reference to the subframe SF1. However, the movement amount of the optical device in the optical axis direction may be calculated with reference to any subframe SF. Each photoelectric conversion element of the distance sensor 102 is not limited to a specific photoelectric conversion element. However, using a SPAD sensor including an avalanche photodiode is advantageous in shortening the subframe period required to ensure the same accuracy as compared with the case where another type of sensor such as a CMOS sensor is used because there is no readout noise in principle. Accordingly, an optical device using a SPAD sensor is advantageous in shortening the distance measurement frame period and can reduce the movement amount data required for correction assuming that the moving speed of the optical device in the optical axis direction remains the same.

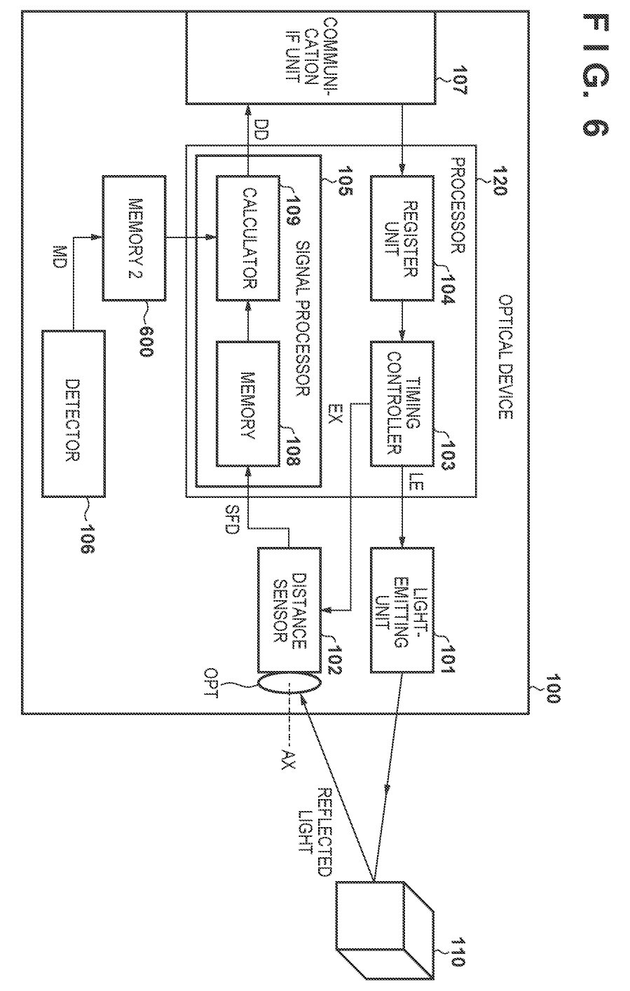

An optical device 100 according to the second embodiment will be described below with reference to FIG. 6. Matters that are not referred to in the second embodiment can comply with the first embodiment. FIG. 6 shows the arrangement of the optical device 100 according to the second embodiment. The optical device 100 according to the second embodiment can include a memory 600 that stores an output from a detector 106 (movement amount data indicating the movement amount of the optical device 100 or a distance sensor 102 in an optical axis direction AX). A processor 120 can perform reduction processing based on an output from the detector 106 which is stored in the memory 600. The processor 120 can, for example, acquire a plurality of subframes for generating a distance measurement frame and then generate distance information corrected based on the plurality of subframes stored in the memory 108 and the movement amount data stored in the memory 600. The second embodiment is advantageous, for example, in a case where the delay of a data output from the detector 106 is large.

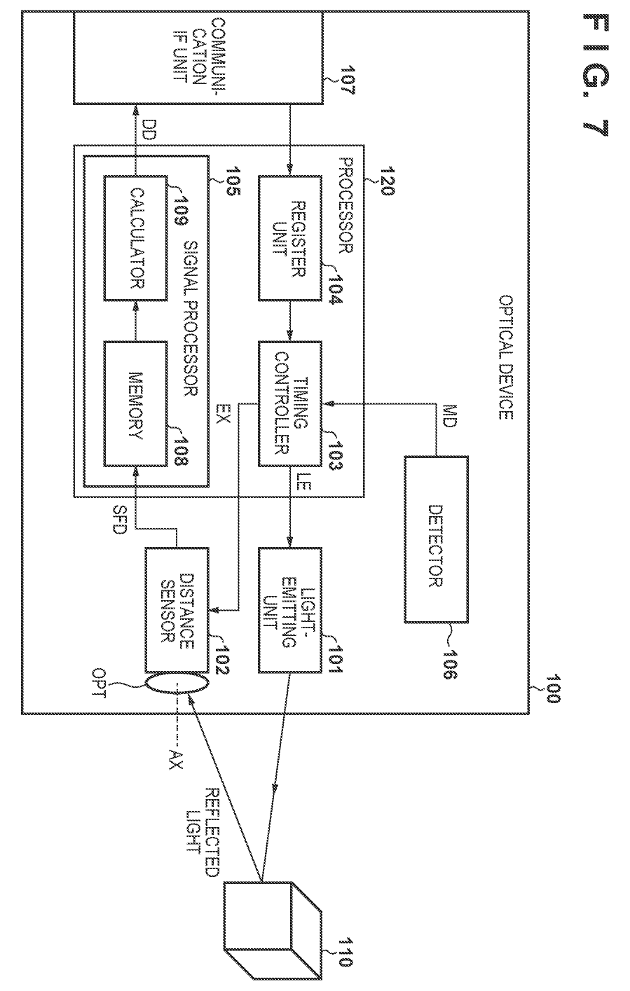

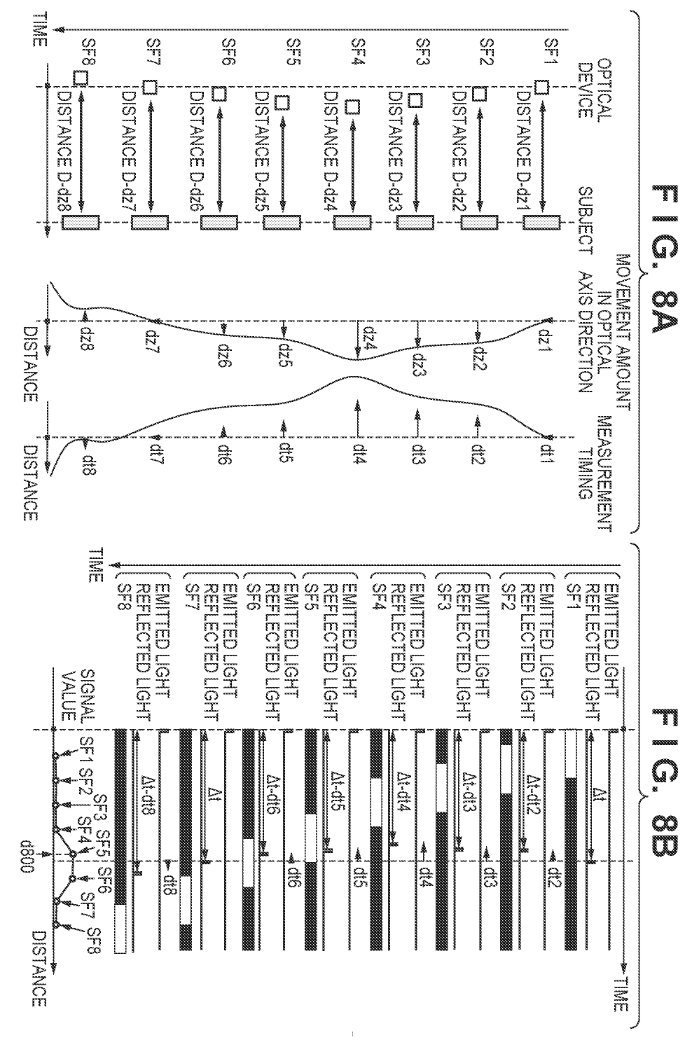

An optical device 100 according to the third embodiment will be described with reference to FIGS. 7 and 8A and 8B. Matters that are not referred to in the third embodiment can comply with the first embodiment. FIG. 7 shows the arrangement of the optical device 100 according to the third embodiment. According to the third embodiment, a detector 106 provides its output (movement data MD) to a processor 120 (a timing controller 103). Based on the output (movement data MD) from the detector 106, the processor 120 (the timing controller 103) sends a second timing signal for controlling each of a plurality of measurement periods for acquiring a plurality of subframes SF to a distance sensor 102. More specifically, in the case shown in FIG. 7, the detector 106 provides its output (the movement data MD) to the timing controller 103. The timing controller 103 sends, to the distance sensor 102, an exposure control signal EX as the second timing signal for controlling each of a plurality of measurement periods for acquiring the plurality of subframes SF based on the output (the movement data MD) from the detector 106.

FIGS. 8A and 8B schematically show reduction processing (correction processing) in the optical device 100 according to the third embodiment. FIG. 8A shows the positional relationship between the optical device 100 and the object 110 in subframes SF1 to SF8. In this case, as indicated by movement amounts dz1 to dz8, the optical device 100 moves in an optical axis direction AX in the subframes SF1 to SF8. In this case, dz1 and dz7 are 0. The notation in FIG. 8B is the same as that in FIG. 3B. As shown in FIG. 8B, as the optical device 100 moves in the optical axis direction AX, the time difference between the timing at which the light-emitting unit 101 emits light and the timing at which reflected light enters the distance sensor 102 shifts from Δt. Note that dt2 to dt6 and dt8 are the values obtained by converting movement amounts dz2 to dz6 and dz8 into times (the values obtained by dividing the movement amounts by the luminous fluxes). The exposure periods indicated by the white bars are respectively adjusted by dt2 to dt6 and dt8 with respect to the exposure period when the correction amount is 0.

The distance measuring method executed in the optical device 100 according to the third embodiment can include a measurement step and a generation step. In the measurement step, the distance sensor 102 can be made to execute measurement at a plurality of measurement timings determined based on the movement of the distance sensor 102 in the optical axis direction AX of the distance sensor 102. In the generation step, distance information can be generated based on an output from the distance sensor 102 in the measurement step.

In the case shown in FIGS. 8A and 8B, in the periods for acquiring the subframes SF5 and SF6, reflected light from the object 110 is detected by the distance sensor 102, and the signal values in the subframes SF5 and SF6 are larger than those in the remaining subframes. A calculator 109 can determine a distance d800 between the optical device 100 and an object 110 based on the signal values in the subframes SF1 to SF8. The calculator 109 can determine the leading edge positions of the signal values in the subframes SF1 to SF8 and specify, from the leading edge positions, the subframe (in this case, the subframe SF5) in which the object 110 is detected. The calculator 109 can determine the distance (distance information) based on the middle position in the exposure period of the specified subframe. In the case shown in FIGS. 8A and 8B, the distance sensor 102 detects reflected light only in the subframes SF5 and SF6 in spite of the movement of the optical device 100 in the optical axis direction as in the case shown in FIGS. 3A and 3B showing the case where the optical device 100 moves in the optical axis direction. This makes it possible to cancel out or reduce the influence (error factor) of the movement amount of the optical device 100 in the optical axis direction AX, thereby reducing the distance measurement error.

Exposure period adjustment may be executed in a predetermined cycle (for example, a timing within each exposure period when the correction amount is 0), executed at the timing at which the calculation of dt1 to dt8 is completed, or another timing. In addition, the same adjustment amount may be provided for at least one subframe period. Alternatively, the same adjustment amount may be provided for all the subframe periods for one distance measurement frame.

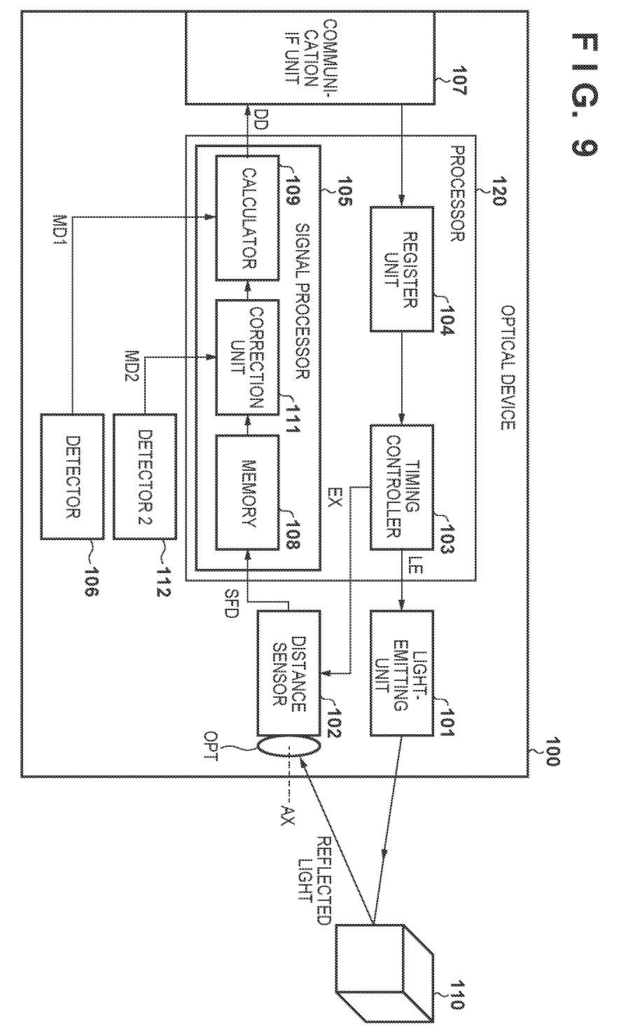

The arrangement and operation of an optical device 100 according to the fourth embodiment will be described below with reference to FIGS. 9, 10A, 10B, 11A, 11B, and 12. Matters that are not referred to in the fourth embodiment can comply with at least one of the first to third embodiments. FIG. 9 shows the arrangement of the optical device 100 according to the fourth embodiment. The optical device 100 according to the fourth embodiment includes a second detector 112 that detects information concerning at least one of the movement of the distance sensor 102 in a direction orthogonal to the optical axis direction AX and the rotation (for example, the tilt with respect to the optical axis direction) of the distance sensor 102. The processor 120 generates the distance information DD by correcting the information obtained from an output from the distance sensor 102 based on outputs from the first detector 106 and the second detector 112 in a measurement period in which the distance sensor 102 performs measurement. The processor 120 or a signal processor 105 can include, for example, a correction unit 111 that performs shake correction based on an output from the second detector 112 with respect to a plurality of subframes SFD stored in the memory 108. The calculator 109 can perform the above reduction processing for a plurality of subframes having undergone shake correction by the correction unit 111. The second detector 112 can include, for example, a gyro sensor and a circuit that processes an output from the gyro sensor.

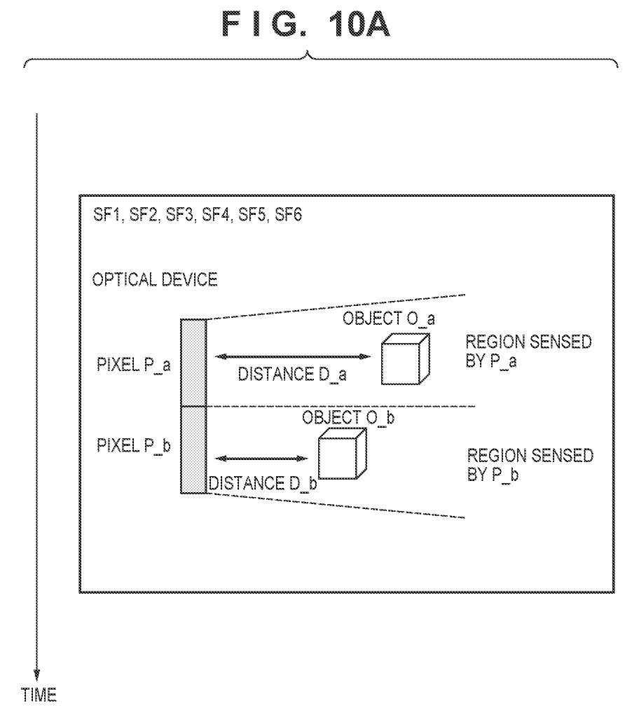

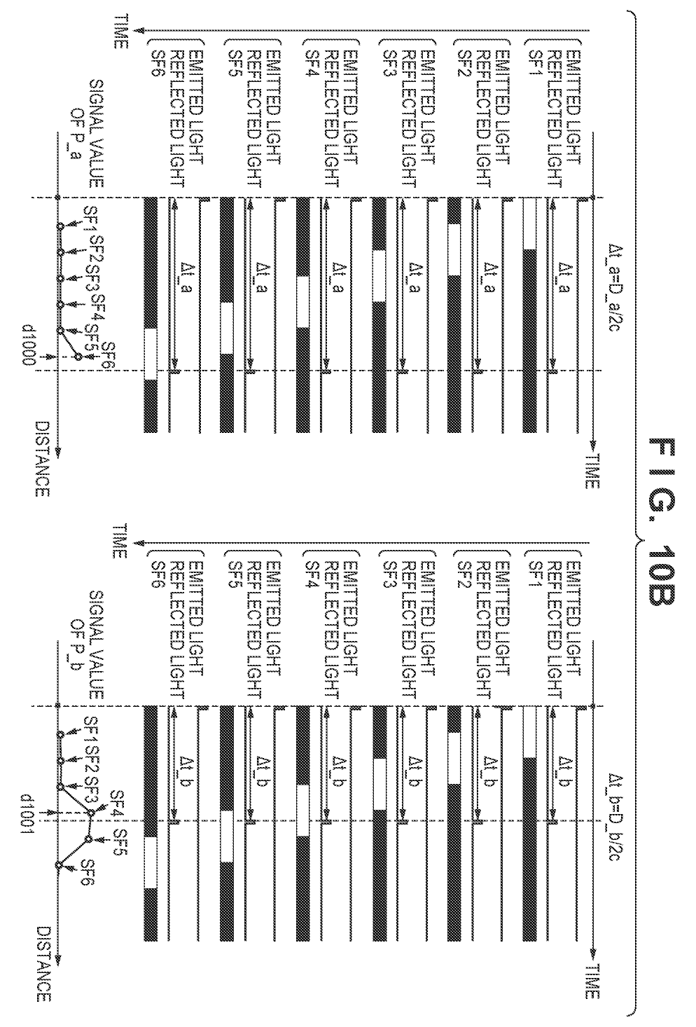

FIGS. 10A and 10B schematically show the operation of the optical device 100 in a case where the second detector 112 detects no information in a period for acquiring a distance measurement frame. In the following description, for the sake of simplicity, assume that the number of subframes SF is six, and the number of pixels of the distance sensor 102 of the optical device 100 is two. In addition, for the sake of simplicity, assume that the optical device 100 (the distance sensor 102) does not move in the optical axis direction AX. FIG. 10A exemplarily shows the positional relationship between a pixel group in the subframes SF1 to SF6 and a target object 910. In this description, assume that an object O_a is located in a region where a pixel P_a senses, an object O_b is located in a region where a pixel P_b senses, and there are distances D_a and D_b between the optical device 100 and the objects O_a and O_b. Consider first a case where the second detector 112 detects no information over six subframe periods.

The left column of FIG. 10B exemplarily shows the light emission timing of a light-emitting unit 101 in each of the subframes SF1 to SF6, the incident timing of reflected light on the pixel P_a, the exposure timing of the pixel P_a, and the signal value of the pixel P_a. In the pixel P_a, reflected light is detected in the subframe SF6. The right column of FIG. 10B exemplarily shows the light emission timing of the light-emitting unit 101 in each of the subframes SF1 to SF6, the incident timing of reflected light entering a pixel P_b, the exposure timing of the pixel P_b, and the signal value of the pixel P_b. In the pixel P_b, reflected light is detected in the subframes SF4 and SF5. Concerning the pixel P_a, the calculator 109 can specify a subframe (in this case, the subframe SF6) in which the object 110 is detected from the leading edge position and determine a distance (distance information) d1000 based on the middle position in the exposure period of the specified subframe. Concerning the pixel P_b, the calculator 109 can specify a subframe (the subframe SF4 in this case) in which the object 110 is detected from the leading edge position and determine a distance (distance information) d1001 based on the middle position in the exposure period of the specified subframe.

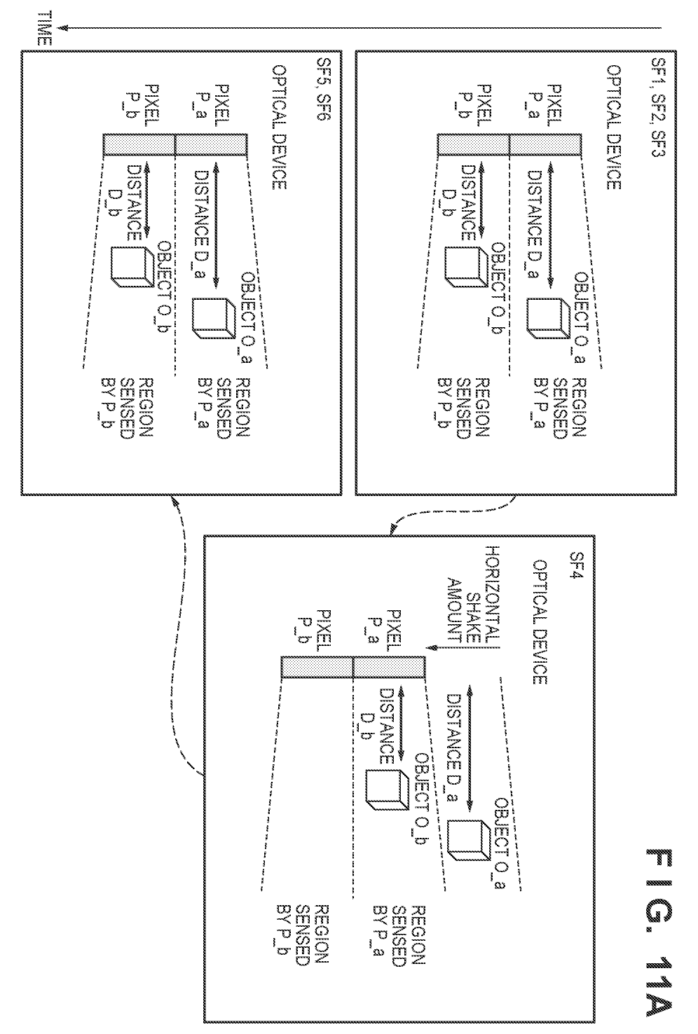

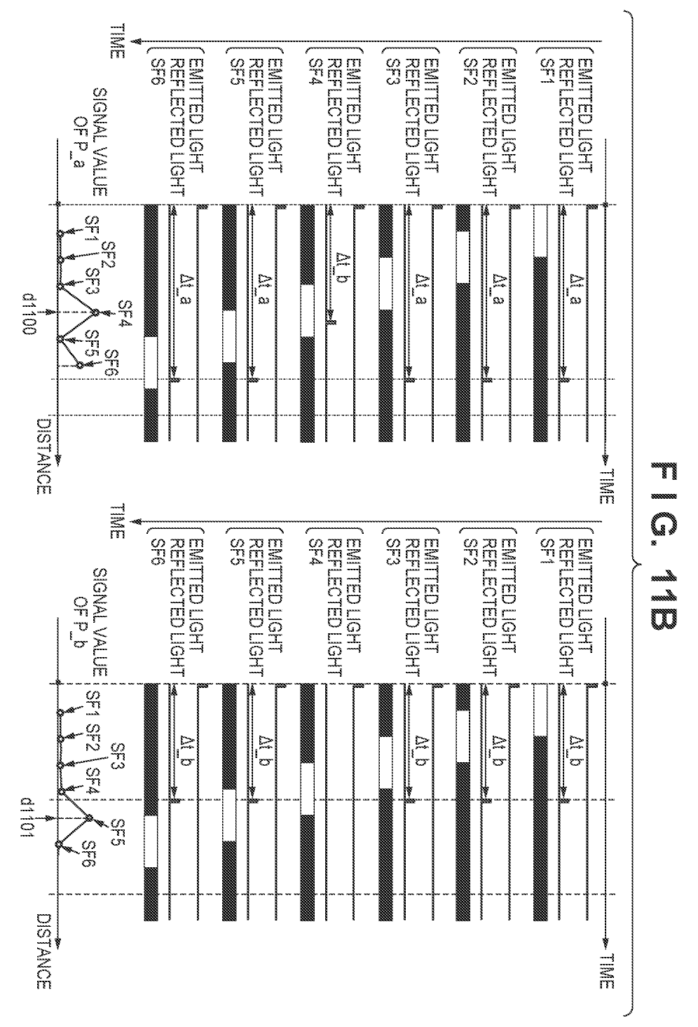

FIGS. 11A and 11B schematically show the operation (a comparative example) of the optical device 100 in a case where although the second detector 112 detects information in a period for acquiring a distance measurement frame, the correction unit 111 executes no correction. FIG. 11A exemplarily shows the positional relationship between a pixel group and the target object 910 in the subframes SF1 to SF6. Assume that the second detector 112 detects the movement of the optical device 100 in a direction orthogonal to the optical axis direction AX only in the subframe SF4 unlike the case shown in FIG. 10A. Assume that the movement amount of the optical device 100 is equal to or less than the size of the light-receiving region of the distance sensor 102.

The left column of FIG. 11B exemplarily shows the light emission timing of the light-emitting unit 101 in each of the subframes SF1 to SF6, the incident timing of reflected light entering the pixel P_a, the exposure timing of the pixel P_a, and the signal value of the pixel P_a. The pixel P_a detects reflected light also in the subframe SF4 unlike the case shown in FIG. 10B. The right column of FIG. 11B exemplarily shows the light emission timing of the light-emitting unit 101 in each of the subframes SF1 to SF6, the incident timing of reflected light on the pixel P_b, the exposure timing of the pixel P_b, and the signal value of the pixel P_b. The pixel P_b detects no reflected light in the subframe SF4. This is because the object O_b has entered the region from which reflected light is expected to be incident on the pixel P_a upon at least the movement or rotation of the optical device 100. As a result, if a distance value is calculated from the leading edge position, the estimated distance values in the pixels P_a and P_b are respectively d1100 and d1101. Accordingly, an error occurs in the distance value to be estimated.

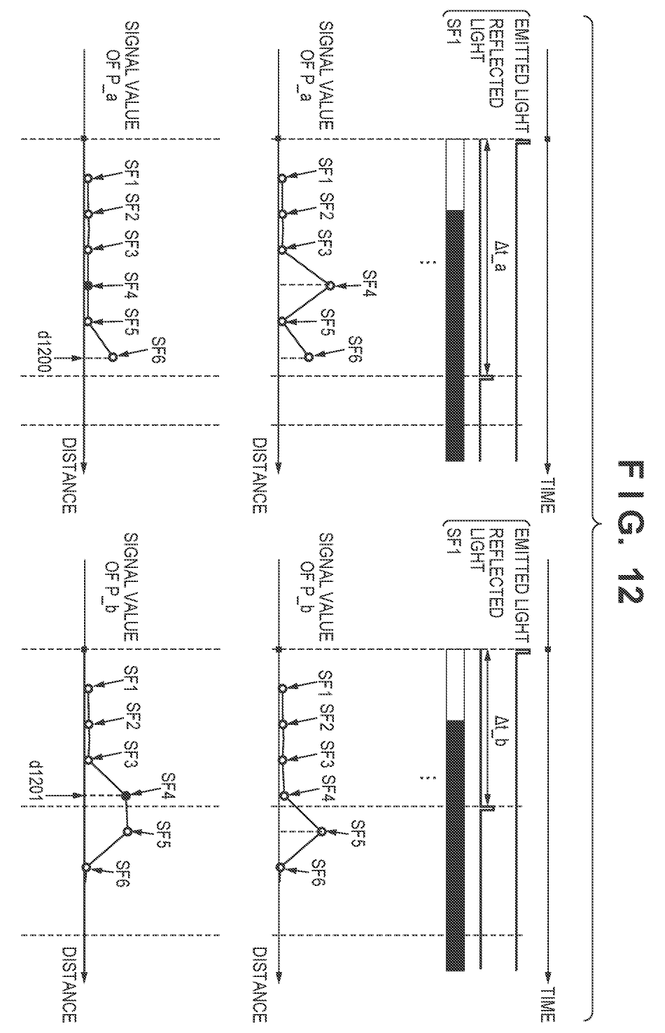

The middle row of FIG. 12 schematically shows the operation (a comparative example) of the optical device 100 in a case where although the second detector 112 detects information in a period in which a distance measurement frame is acquired, the correction unit 111 does not execute correction based on the information. The lower row of FIG. 12 schematically shows the operation of the optical device 100 in a case where the second detector 112 detects information in a period in which a distance measurement frame is acquired, and the correction unit 111 executes correction based on the information.

In the lower row of FIG. 12, the signal value (black circle) of the pixel P_b in the subframe SF4 exemplarily shows the result obtained by executing correction by using the correction unit 111. In addition, in the lower row of FIG. 12, there is no signal value for the replacement of the signal value of the pixel P_a in the subframe SF4. Accordingly, it is possible to use, for example, a method of replacing the signal value with the average value of values in subframes before and after the subframe SF4. With this operation, a distance d1200 and a distance d1201 respectively become estimated distance values at the pixel P_a and the pixel P_b. This makes it possible to obtain the same result as that obtained in a case where there is neither the movement of the distance sensor 102 nor the rotation of the distance sensor 102 in a direction orthogonal to the optical axis direction AX.

For the sake of simplicity, the above has exemplified the case where the distance sensor 102 is constituted by two pixels, and horizontal movement has occurred only in the array direction of pixels. However, the distance sensor 102 may have a plurality of pixels arranged two-dimensionally.

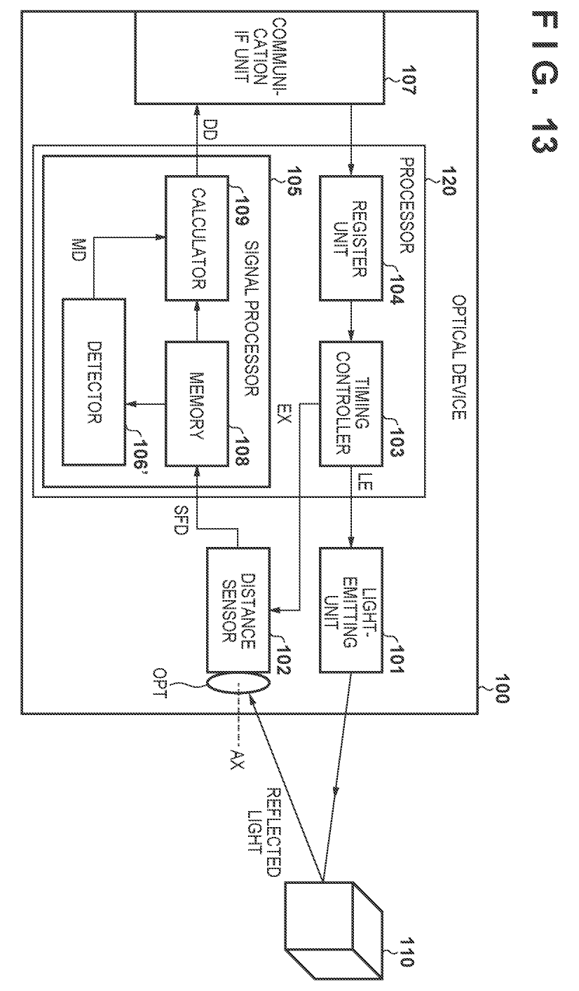

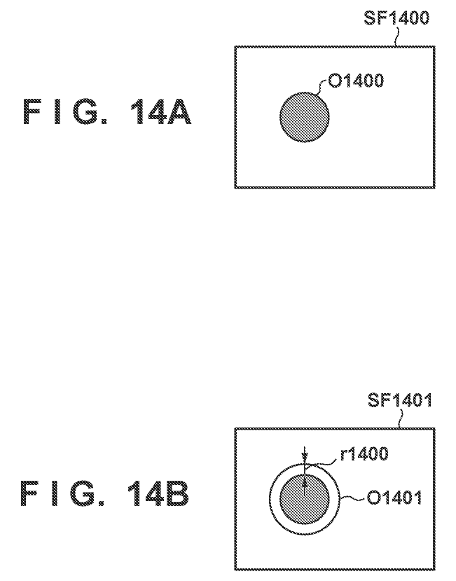

The arrangement and operation of an optical device 100 according to the fifth embodiment will be described below with reference to FIGS. 13 and 14A and 14B. Matters that are not referred to in the fifth embodiment can comply with at least one of the first to fourth embodiments. In the fifth embodiment, the detector 106 is replaced with a detector 106’. The detector 106’ can be incorporated in a processor 120. More specifically, for example, the detector 106’ can be incorporated in a signal processor 105.

For example, the detector 106’ can be configured to detect the movement of a distance sensor 102 in an optical axis direction AX based on a plurality of subframes SFD stored in a memory 108. In other words, the detector 106’ can be configured to detect the movement of the distance sensor 102 in the optical axis direction AX by image processing.

FIGS. 14A and 14B exemplarily show two consecutive subframes SD1400 and SF1401 of a plurality of subframes SF for forming a distance frame. The detector 106’ can generate movement amount data MD indicating the movement of the distance sensor 102 in the optical axis direction AX from an image of an object 110 commonly appearing in the subframes SD1400 and SF1401 from the subframes SD1400 and SF1401. A subframe SF1400 is a subframe immediately before the subframe SF1401. If the object 110 is a planar object or the like, the image of the object commonly appears in two consecutive subframes. It is, therefore, possible to calculate a variable magnification from two or more consecutive subframes and calculate the movement amount of a distance sensor 102 in the optical axis direction AX based on the variable magnification.

For example, an image O1400 of the object 110 can be present in the subframe SF1400. In the subframe SF1401, if the optical device 100 has moved in the optical axis direction AX to make the image O1400 change to an image O1401, a variable magnification r1400 can be calculated based on the change. The detector 106’ can calculate a magnification ratio and then can calculate the movement amount of the distance sensor 102 in the optical axis direction AX based on the variable magnification. Such an arrangement can also execute reduction processing like the first to fourth embodiments.

In this case, for the sake of simplicity, the object 110 is assumed to be a planar object. However, using an AI or the like that detects an object can estimate a variable magnification concerning an object other than objects having simple shapes and calculate the movement amount of the distance sensor 102 in the optical axis direction AX.

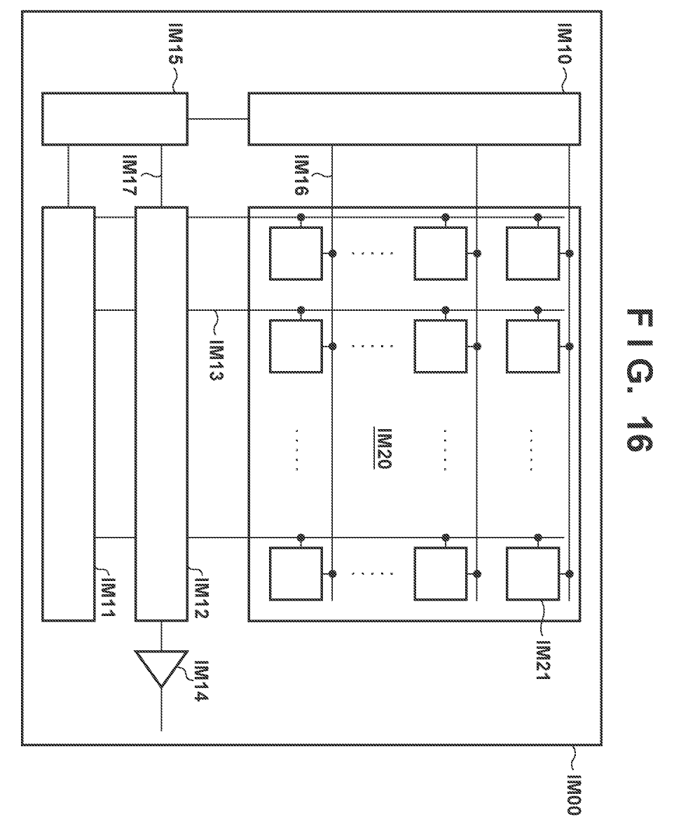

FIG. 16 shows an example of the arrangement of an image sensor IM00 that can be incorporated in the distance sensor 102. The image sensor IM00 may be formed of one semiconductor substrate or formed by stacking a plurality of semiconductor substrates (semiconductor layers). The image sensor IM00 can include a pixel array IM20 having a plurality of pixels IM21 arrayed to form a plurality of rows and a plurality of columns. The image sensor IM00 can include a readout circuit IM12 that reads out the signal generated by each pixel IM21 of the pixel array IM20 and a control pulse generation unit IM15. The image sensor IM00 can also include a horizontal scanning circuit unit IM11, a plurality of signal lines IM13, a vertical scanning circuit unit IM10, a plurality of signal lines IM16, and an output circuit IM14.

The vertical scanning circuit unit IM10 can be configured to generate a second control pulse upon reception of a first control pulse supplied from the control pulse generation unit IM15 and supply the second control pulse to each pixel IM21. The vertical scanning circuit unit IM10 can include, for example, logical circuits such as a shift register and an address decoder. The horizontal scanning circuit unit IM11 can be configured to supply a column selection signal to the readout circuit IM12. The horizontal scanning circuit unit IM11 can include, for example, logical circuits such as a shift register and an address decoder.

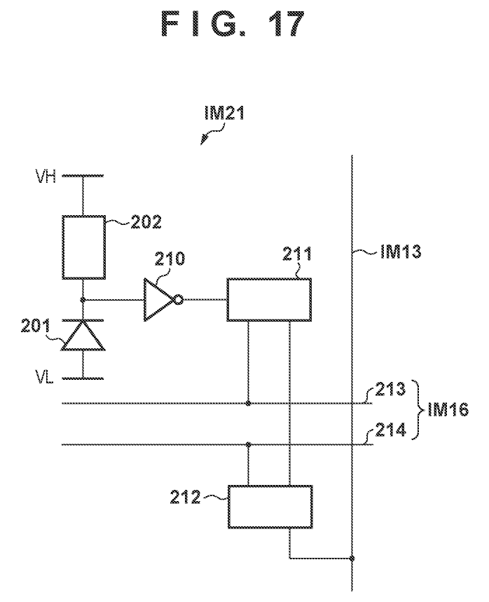

FIG. 17 shows an example of the arrangement of one pixel IM21 in FIG. 16. The pixel IM21 can include an avalanche photodiode (APD) 201 as a photoelectric conversion element. The image sensor IM00 can be configured as an APD image sensor. The APD 201 generates charge pairs corresponding to incident light by photoelectric conversion. The anode of the APD 201 is supplied with a voltage VL (first voltage). The cathode of the APD 201 can be supplied with a voltage VH (second voltage) higher than the voltage VL supplied to the anode. A reverse bias voltage (predetermined voltage) that can cause the APD 201 to perform an avalanche multiplication operation can be supplied between the anode and the cathode. By setting the state in which such reverse bias voltage is supplied between the anode and the cathode, charges generated by the incident light cause an avalanche multiplication operation, thereby generating an avalanche current.

A mode of operating an APD in a state in which the voltage between the anode and the cathode is higher than the breakdown voltage is called a Geiger mode. A mode of operating an APD in a state in which the voltage between the anode and the cathode is around or lower than the breakdown voltage is called a linear mode. An APD operated in the Geiger mode is called an SPAD. For example, the voltage VL (first voltage) is -30 V and the voltage VH (second voltage) is 1 V. The APD 201 may be operated in either the linear mode or the Geiger mode.

A quenching element 202 can be arranged to connect the APD 201 and a power supply for supplying the voltage VH. The quenching element 202 functions as a load circuit (quenching circuit) at the time of signal multiplication by an avalanche multiplication operation, and serves to suppress avalanche multiplication by suppressing the voltage supplied to the APD 201 (quenching operation). In addition, the quenching element 202 serves to return, to the voltage VH, the voltage supplied to the APD 201 by sending a current corresponding to a voltage drop caused by a quenching operation (recharging operation).

A pixel 1121 can include a waveform shaping unit 210, a processing circuit 211, and a selection circuit 212. The waveform shaping unit 210 can output a pulse signal by shaping the potential change of the cathode of the APD 201 obtained at the time of detection of a photon. As the waveform shaping unit 210, for example, an inverter circuit can be used. In FIGS. 4A and 4B, the waveform shaping unit 210 is formed by one inverter but the waveform shaping unit 210 may include a plurality of serially connected inverters or include another circuit having the waveform shaping effect.

The processing circuit 211 can count the pulse signals output from the waveform shaping unit 210 in each subframe period and hold a count value as a signal value. In addition, the processing circuit 211 can be configured to reset a signal held in the processing circuit 211 by supplying a control pulse pRES via a drive wire 213. A control pulse pSEL is supplied from the vertical scanning circuit unit IM10 to the selection circuit 212 via a drive wire 214. This can switch between electrical connection and disconnection between the processing circuit 211 and the signal line IM13. The selection circuit 212 can include, for example, a buffer circuit for outputting signals.

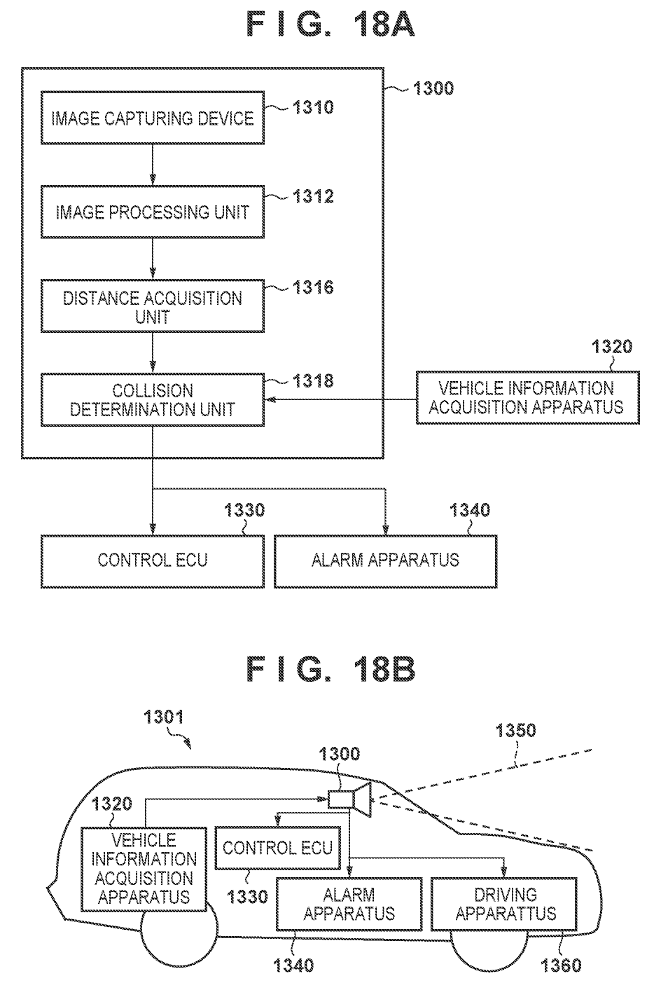

An application example of the optical device 100 described above will be exemplarily described below. FIG. 18A is a block diagram showing the schematic arrangement of an optical system according to one embodiment. FIG. 18B is a block diagram showing the schematic arrangement of a moving body according to one embodiment. FIG. 18A shows an example of an optical system associated with an in-vehicle camera. An optical system 1300 includes an image capturing device 1310. The optical system 1300 includes an image processing unit 1312 that performs image processing for a plurality of image data acquired by the image capturing apparatus 1310. The optical system 1300 also includes a distance acquisition unit 1316 that calculates the distance up to a target object, and a collision determination unit 1318 that determines, based on the calculated distance, whether there is collision possibility. Here, the distance acquisition unit 1316 is an embodiment of the optical device 100 configured to acquire distance information up to a target object by using the Time of Flight (ToF) method. The collision determination unit 1318 may determine collision possibility using one of the pieces of distance information. The distance acquisition unit 1316 may be implemented by exclusively designed hardware, or may be implemented by a software module. The distance acquisition unit 1316 may be implemented by a Field Programmable Gate Array (FPGA), Application Specific Integrated Circuit (ASIC), or the like. Alternatively, the distance acquisition unit 1316 may be implemented by a combination of these.

The optical system 1300 is connected to a vehicle information acquisition apparatus 1320, and can acquire vehicle information such as a vehicle speed, a yaw rate, and a steering angle. The optical system 1300 is also connected to an ECU 1330 that is a control apparatus configured to output a control signal for generating a braking force to the vehicle based on the determination result of the collision determination unit 1318. Furthermore, the optical system 1300 is connected to an alarm apparatus 1340 that generates an alarm to the driver based on the determination result of the collision determination unit 1318. For example, if collision possibility is high as the determination result of the collision determination unit 1318, the ECU 1330 controls a driving apparatus (machine apparatus) 1360 to perform braking, releasing the accelerator pedal, or suppressing the engine output, thereby controlling the vehicle for avoiding collision and reducing damage. The alarm apparatus 1340 sounds an alarm, displays alarm information on the screen of a car navigation system or the like, or applies a vibration to the seat belt or a steering wheel, thereby making an alarm to the user.

In this embodiment, the periphery of the vehicle (moving body 1301), for example, the front or rear side is captured by the optical system 1300. FIG. 18B shows the optical system when capturing the front side (image capturing range 1350) of the vehicle. The vehicle information acquisition apparatus 1320 sends an instruction to the optical system 1300 or the image capturing apparatus 1310. With this configuration, it is possible to further improve the accuracy of distance measurement.

An example in which control is executed so as not to collide with another vehicle has been explained above. The optical system 1300 can also be applied to control of performing automated driving following another vehicle or control of performing automated driving without deviating from a lane. Furthermore, the optical system 1300 can be applied not only to a vehicle such as an automobile but also to, for example, a moving body (moving apparatus) such as a ship, an airplane, or an industrial robot. The moving body includes one or both of a driving force generation unit that generates a driving force mainly used for moving the moving body and a rotating body mainly used for moving the moving body. The driving force generation unit can be an engine, a motor, or the like. The rotating body can be a tire, a wheel, a ship screw, an aircraft propeller, or the like. In addition, the photoelectric conversion system can be applied not only to a moving body but also to equipment that broadly uses object recognition, such as an intelligent transport system (ITS).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-096895, filed June 14, 2024, which is hereby incorporated by reference herein in its entirety.

What is claimed is:

1. An optical device that includes a distance sensor and obtains distance information based on an output from the distance sensor, the device comprising a processor configured to perform reduction processing of reducing, based on movement of the distance sensor in an optical axis direction of the distance sensor, an influence of the movement on the distance information.

2. The device according to claim 1, further comprising a detector configured to detect movement of the distance sensor in the optical axis direction,
wherein the processor performs the reduction processing based on an output from the detector.

3. The device according to claim 2, further comprising a memory configured to store an output from the detector,
wherein the processor performs the reduction processing based on an output from the detector which is stored in the memory.

4. The device according to claim 2, wherein the detector includes at least one of an acceleration sensor and a displacement sensor.

5. The device according to claim 2, wherein the processor generates the distance information by correcting information obtained from an output from the distance sensor based on an output from the detector in a measurement period in which the distance sensor performs measurement.

6. The device according to claim 5, wherein the distance sensor generates a distance measurement frame constituted by a plurality of subframes differing in measurement period.

7. The device according to claim 6, wherein the distance sensor includes a photoelectric conversion element, and the measurement period is an exposure period of the photoelectric conversion element.

8. The device according to claim 5, further comprising a second detector configured to detect at least one of movement of the distance sensor in a direction orthogonal to the optical axis direction and rotation of the distance sensor,
wherein the processor generates the distance information by correcting information obtained from an output from the distance sensor based on outputs from the detector and the second detector in the measurement period.

9. The device according to claim 2, wherein the distance sensor generates a distance measurement frame constituted by a plurality of subframes differing in measurement period, and
the processor sends, to the distance sensor, a timing signal for controlling each of a plurality of measurement periods for acquiring the plurality of subframes based on an output from the detector.

10. The device according to claim 9, wherein the distance sensor includes a photoelectric conversion element, and the measurement period is an exposure period of the photoelectric conversion element.

11. The device according to claim 1, wherein the distance sensor includes a photoelectric conversion element and generates a distance measurement frame constituted by a plurality of subframes differing in exposure period, and
the processor detects movement of the distance sensor in the optical axis direction based on the plurality of subframes.

12. The device according to claim 1, wherein the distance sensor includes a SPAD sensor.

13. The device according to claim 1, further comprising a light-emitting unit,
wherein the distance sensor operates at a timing corresponding to a light emission timing of the light-emitting unit.

14. An optical system comprising:
an optical device defined in claim 1;
and a signal processor configured to process a signal output from the optical device.

15. A moving body including an optical device defined in claim 1, the body comprising a controller configured to control movement of the moving body by using a signal output from the optical device.

16. A distance measuring method of measuring a distance using a distance sensor, the method comprising:
acquiring first distance information by using the distance sensor in a given period;
detecting movement of the distance sensor in an optical axis direction of the distance sensor in the period; and
generating second distance information based on the first distance information acquired in the acquiring and a detection result obtained in the detecting.

17. A distance measuring method of measuring a distance by using a distance sensor, the method comprising:
causing the distance sensor to execute measurement at a plurality of measurement timings determined based on movement of the distance sensor in an optical axis direction of the distance sensor; and
generating distance information based on an output from the distance sensor in the measuring.
